(19) United States
(12) Patent Application Publication
(10) Pub. No.: US 2019/0279300 A1
(43) Pub. Date: Sep. 12, 2019

(54) Trading System and Electronic Device

(71) Applicant: Kyocera Document Solutions Inc., Osaka (JP)

(72) Inventor: Kentaro Okamoto, Osaka (JP)

(73) Assignee: Kyocera Document Solutions Inc.

(21) Appl. No.: 16/288,115

(22) Filed: Feb. 28, 2019

(30) Foreign Application Priority Data
Mar. 7, 2018 (JP) 2018-040378

(51) Int. Cl. G06Q 40/04

(52) U.S. Cl. CPC G06Q 40/04; H04L 9/14

(57) ABSTRACT

A trading system includes a trading management system and an electronic device. The trading management system manages a trading. The electronic device has an operation check function. The operation check function checks whether an object of the trading validly operates for the trading. The trading management system includes at least one of a confirmation of the valid operation of the object by the operation check function before sending the object by a seller of the object and a confirmation of the valid operation of the object by the operation check function after receiving the object by a buyer of the object, as a condition of a completion of the trading.

### INCORPORATION BY REFERENCE

This application is based upon, and claims the benefit of priority from, corresponding Japanese Patent Application No. 2018-040378 filed in the Japan Patent Office on Mar. 7, 2018, the entire contents of which are incorporated herein by reference.

### BACKGROUND

Unless otherwise indicated herein, the description in this section is not prior art to the claims in this application and is not admitted to be prior art by inclusion in this section.

As a typical trading system, there has been known a trading system where whether or not a trading object validly operates is confirmed by a human.

### SUMMARY

A trading system according to one aspect of the disclosure includes a trading management system and an electronic device. The trading management system manages a trading. The electronic device has an operation check function. The operation check function checks whether an object of the trading validly operates for the trading. The trading management system includes at least one of a confirmation of the valid operation of the object by the operation check function before sending the object by a seller of the object and a confirmation of the valid operation of the object by the operation check function after receiving the object by a buyer of the object, as a condition of a completion of the trading.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram of a trading system according to one embodiment of the disclosure;

FIG. 2 illustrates a block diagram of an owner management server according to the one embodiment;

FIG. 3 illustrates exemplary owner history information illustrated in FIG. 2;

FIG. 4 illustrates exemplary cryptographic key information illustrated in FIG. 2;

FIG. 5 illustrates a block diagram of a trading management server according to the one embodiment;

FIG. 6 illustrates exemplary delivery-company arrangement information illustrated in FIG. 5;

FIG. 7 illustrates exemplary product management information illustrated in FIG. 5;

FIG. 8 illustrates a block diagram of an image forming apparatus in the case of an MFP according to the one embodiment;

FIG. 9 illustrates a block diagram of a computer according to the one embodiment;

FIG. 10 illustrates an operation of the image forming apparatus according to the one embodiment when a trading object is set to a “sales mode;”

FIG. 11 illustrates an operation of the trading system according to the one embodiment when a seller of the trading object registers the trading object on a trading site;

FIG. 12 illustrates an operation of the trading system according to the one embodiment when the seller of the trading object cancels the register of the trading object on the trading site;

FIG. 13 illustrates an operation of the image forming apparatus according to the one embodiment when the “sales mode” of the trading object is canceled;

FIG. 14 illustrates an operation of the trading system according to the one embodiment when the trading object registered on the trading site is purchased; and

FIG. 15 illustrates an operation of the trading system according to the one embodiment when a buyer of the trading object receives the trading object.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes embodiments of the disclosure by referring to the drawings.

First, a configuration of a trading system according to one embodiment of the disclosure will be described.

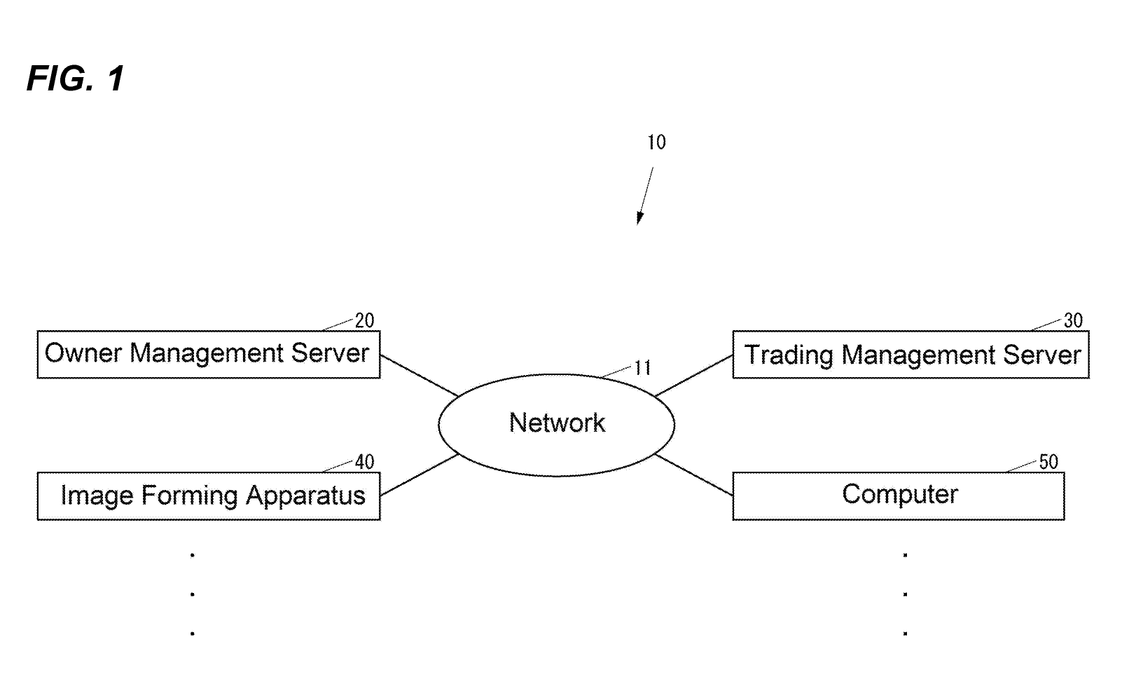

FIG. 1 illustrates a block diagram of a trading system 10 according to the embodiment.

The trading system 10 illustrated in FIG. 1 is managed by a manufacturer of an object for trading (hereinafter referred to as “trading object”) on the trading system 10. The manufacturer of the trading object assigns identification information (hereinafter referred to as “user ID”) to a user of the trading system 10. The user of the trading system 10 can sell the trading object on the trading system 10 for various reasons, for example, that the trading object is no longer necessary.

The trading object includes an image forming apparatus such as a Multifunction Peripheral (MFP), a printer-only machine, a copy-only machine, a FAX-only machine, and a scanner-only machine, and an object used by the image forming apparatus. Here, the object used by the image forming apparatus includes optional equipment such as a finisher, and expendables such as a toner container.

The trading system 10 includes an owner management server 20, a trading management server 30, an image forming apparatus 40, and a computer 50 such as a Personal Computer (PC). The owner management server 20 is an owner management system that manages an owner of an image forming apparatus and an object used by the image forming apparatus. The trading management server 30 is a trading management system that manages the trading. The image forming apparatus 40 is an electronic device that has an operation check function to check whether or not the trading object validly operates for the trading.

The owner management server 20, the trading management server 30, the image forming apparatus 40, and the computer 50 are mutually communicable via a network 11 such as Internet.

The trading system 10 can include at least one image forming apparatus similar to the image forming apparatus 40 in addition to the image forming apparatus 40. Similarly, the trading system 10 can include at least one computer similar to the computer 50 in addition to the computer 50.

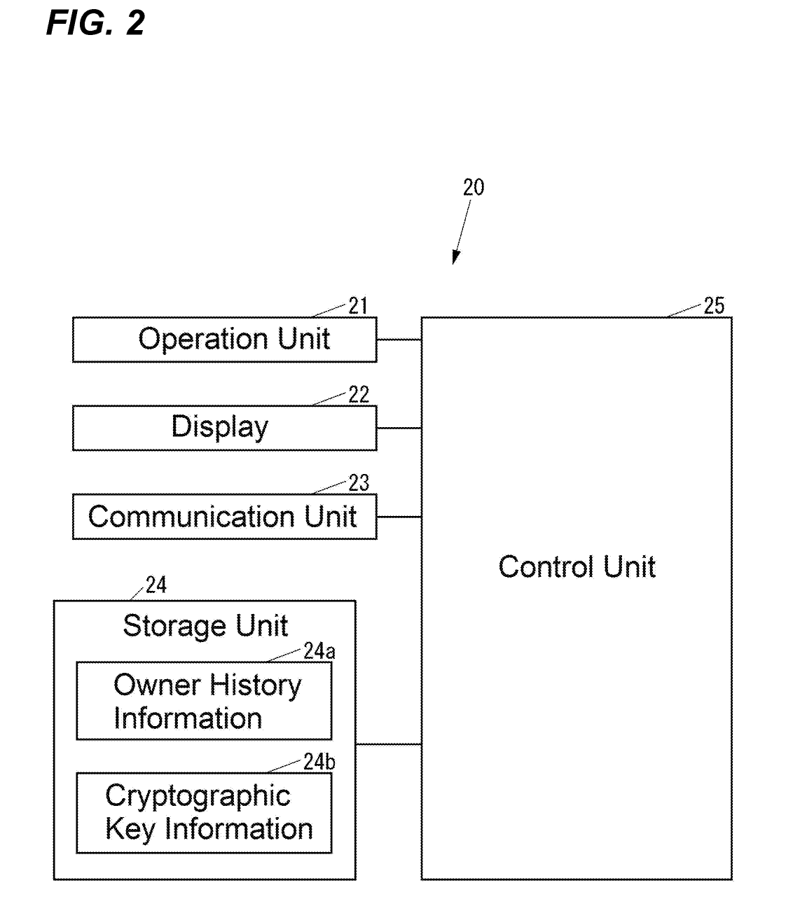

FIG. 2 illustrates a block diagram of the owner management server 20.

As illustrated in FIG. 2, the owner management server 20 includes an operation unit 21, a display 22, a communication unit 23, a storage unit 24, and a control unit 25. The operation unit 21 is an input device such as a keyboard and a computer mouse to which various operations are input. The display 22 is a display device such as a Liquid Crystal Display (LCD) that displays various kinds of information. The communication unit 23 is a communication device that communicates with an external device via the network such as a Local Area Network (LAN) or the Internet, or directly by wire or wirelessly without the network. The storage unit 24 is a non-volatile storage device such as a semiconductor memory and a Hard Disk Drive (HDD) that store various kinds of information. The control unit 25 controls the whole owner management server 20.

The storage unit 24 stores owner history information 24a representing a history of owners.

The storage unit 24 stores cryptographic key information 24b representing cryptographic keys for changing a “sales mode” of the trading object from an uncancelable state to a cancelable state. Here, the “sales mode” is a mode in a state where a specific function of the trading object is unusable. The specific function may be, for example, ordinarily usable every function of the trading object. For example, in the “sales mode,” the ordinary usable every function of the trading object may be unusable, and the operation check function may be usable only at one time. The “ordinary usable every function” may be, for example, every function usable by a general user of the trading object, that is, every function excluding the operation check function that is usable by only a service person of the trading object and executed in a maintenance mode for maintenance check of the trading object.

The control unit 25 includes, for example, a Central Processing Unit (CPU), a Read Only Memory (ROM) that stores a program and various data, and a Random Access Memory (RAM) used as a work area of the CPU. The CPU executes the program stored in the ROM or the storage unit 24.

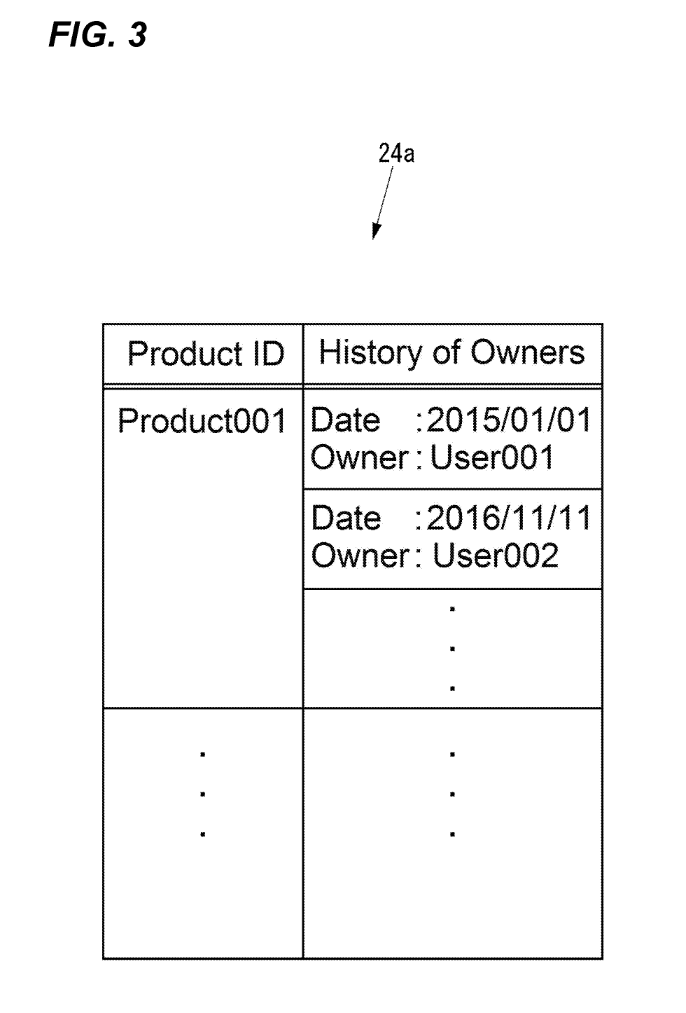

FIG. 3 illustrates exemplary owner history information 24a.

As illustrated in FIG. 3, the owner history information 24a indicates identification information of a product (hereinafter referred to as “product ID”) and the history of product owners associated with each product. The product ID is, for example, a serial number of the product. The history of product owners indicates the user IDs of past and current owners of the product having the history and their associated dates on which the past and current owners of the product having the history became the owners of the product having the history.

The user ID of a first owner of the product having the history is input to the owner history information 24a by a vendor when the product having the history is sold to the first owner. The user IDs of the second and following owners of the product having the history are input to the owner history information 24a by the owner management server 20 when the trading of the product having the history on the trading system 10 is completed.

The date where the first owner of the product having the history became the owner of the product having the history may be input to the owner history information 24a by the vendor when the product having the history was sold to the first owner. Alternatively, after the image forming apparatus stores a date of starting to use the product having the history in a storage medium in the product having the history, when the trading of the product having the history on the trading system 10 is completed, the date stored in the storage medium in the product having the history may be input to the owner history information 24a by the owner management server 20. The dates where the second and following owners of the product having the history became the owners of the product having the history are input to the owner history information 24a by the owner management server 20 when the trading of the product having the history on the trading system 10 is completed.

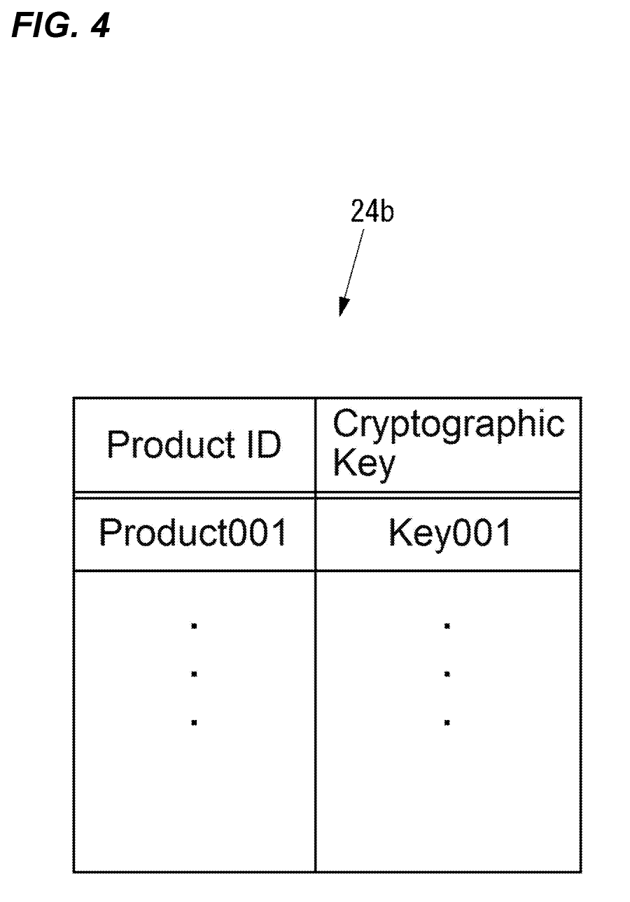

FIG. 4 illustrates exemplary cryptographic key information 24b.

As illustrated in FIG. 4, the cryptographic key information 24b indicates the product IDs and cryptographic keys associated with each product.

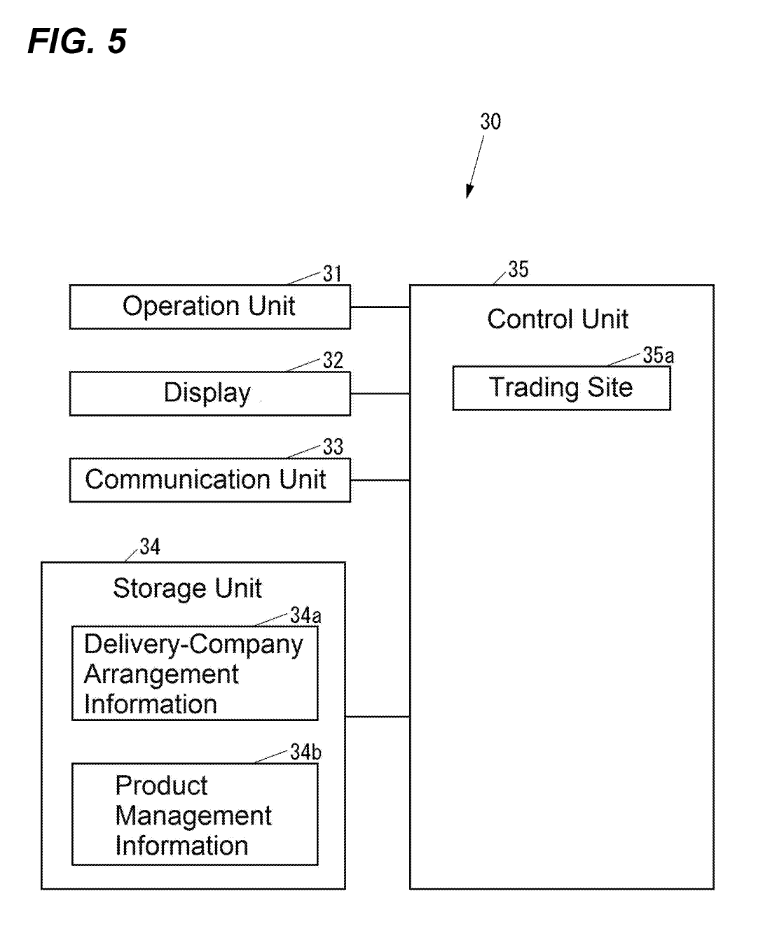

FIG. 5 illustrates a block diagram of the trading management server 30.

As illustrated in FIG. 5, the trading management server 30 includes an operation unit 31, a display 32, a communication unit 33, a storage unit 34, and a control unit 35. The operation unit 31 is an input device such as a keyboard and a computer mouse to which various operations are input. The display 32 is a display device such as an LCD that displays various kinds of information. The communication unit 33 is a communication device that communicates with an external device via the network such as a LAN or the Internet, or directly by wire or wirelessly without the network. The storage unit 34 is a non-volatile storage device such as a semiconductor memory and an HDD that store various kinds of information. The control unit 35 controls the whole trading management server 30.

The storage unit 34 is configured to store delivery-company arrangement information 34a for arranging a delivery company, and product management information 34b for managing the product.

The control unit 35 includes, for example, a CPU, a ROM that stores a program and various data, and a RAM used as a work area of the CPU. The CPU executes the program stored in the ROM or the storage unit 34.

The control unit 35 executes the program stored in the ROM or the storage unit 34 to ensure a trading site 35a as a website that manages the trading.

The trading site 35a manages trading status for each registered trading object. A seller and a buyer of the trading object can login the trading site 35a to check the trading status of the trading involving themselves on the trading site 35a.

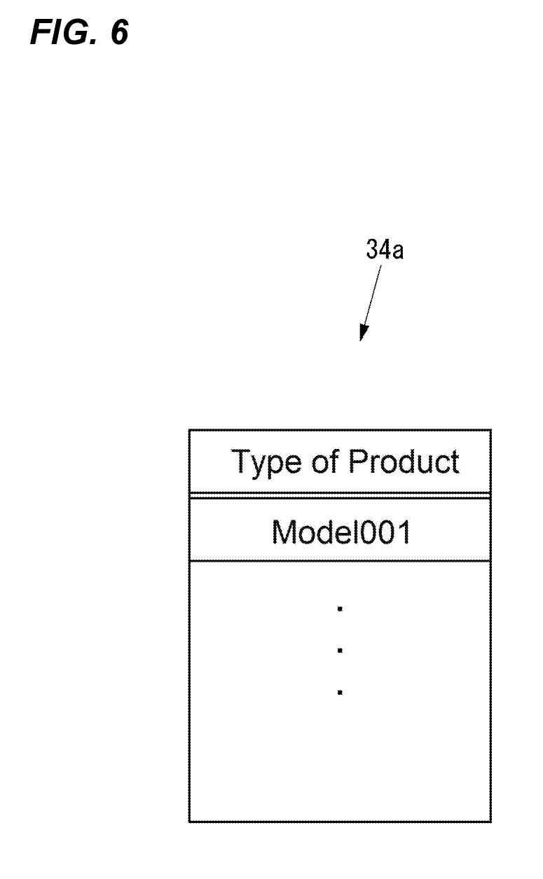

FIG. 6 illustrates exemplary delivery-company arrangement information 34a.

As illustrated in FIG. 6, the delivery-company arrangement information 34a indicates types of the products such as a large-sized product that requires the arrangement of the delivery company.

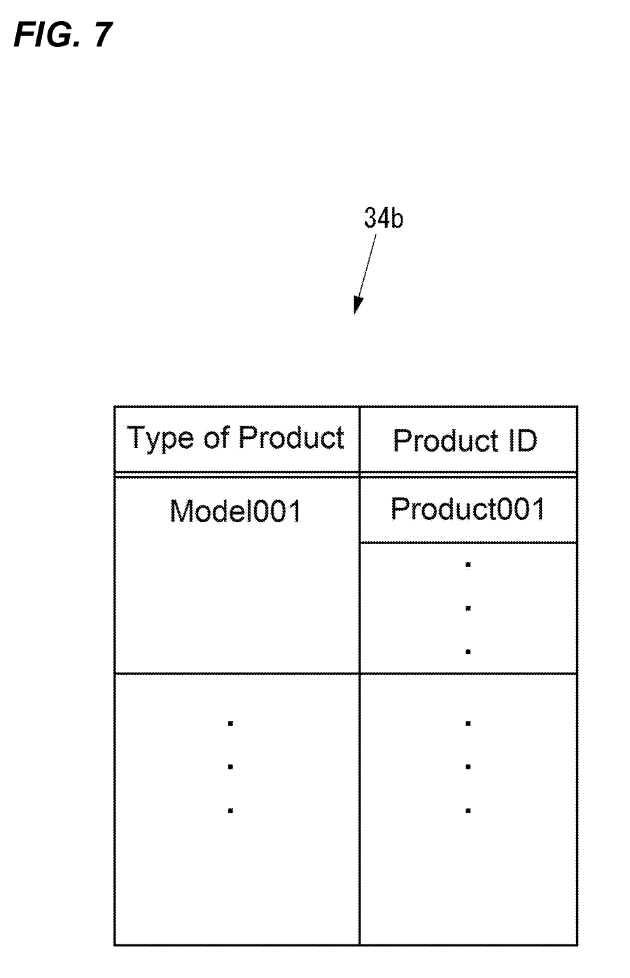

FIG. 7 illustrates exemplary product management information 34b.

As illustrated in FIG. 7, the product management information 34b indicates the product ID for each type of the product.

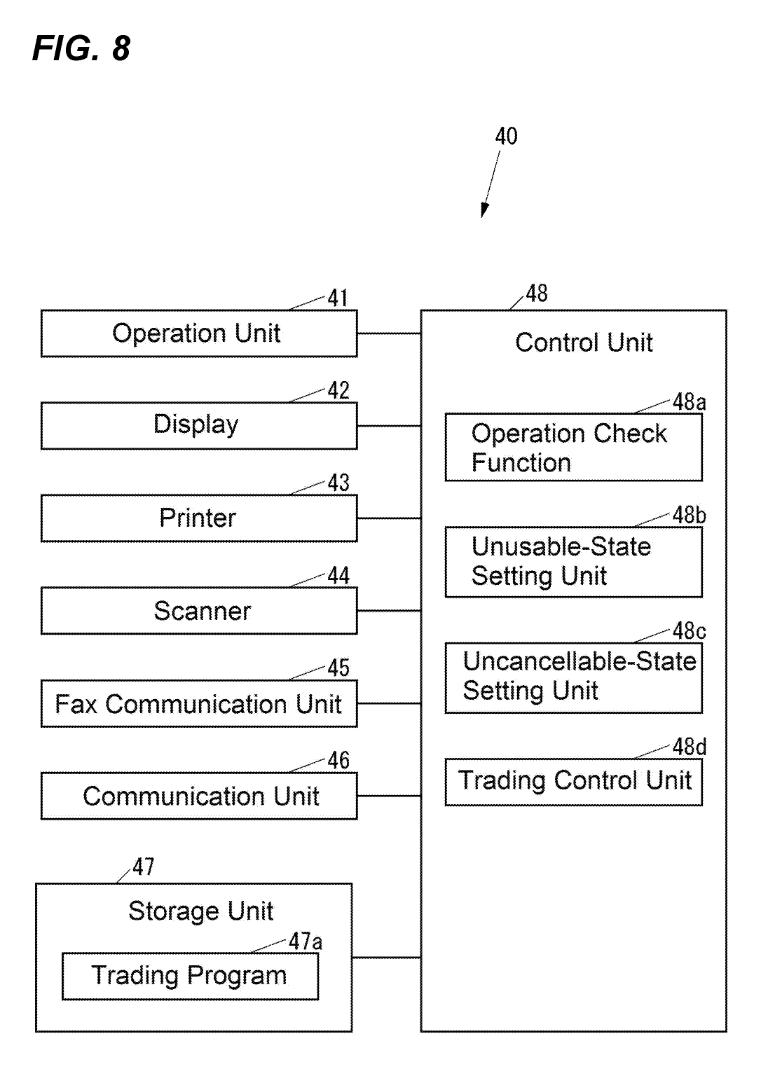

FIG. 8 illustrates a block diagram of the image forming apparatus 40 in the case of an MFP.

As illustrated in FIG. 8, the image forming apparatus 40 includes an operation unit 41, a display 42, a printer 43, a scanner 44, a fax communication unit 45, a communication unit 46, a storage unit 47, and a control unit 48. The operation unit 41 is an operation device such as a button to which various operations are input. The display 42 is a display device such as an LCD that displays various kinds of information. The printer 43 is a print device that prints an image on a recording medium such as a paper sheet. The scanner 44 is a reading device that reads an image from an original document. The fax communication unit 45 is a fax device that performs fax communication with an external facsimile device (not illustrated) via a communication line such as a dial-up line. The communication unit 46 is a communication device that communicates with an external device via a network such as a LAN or the Internet, or directly by wire or wirelessly without the network. The storage unit 47 is a non-volatile storage device such as a semiconductor memory and an HDD that store various kinds of information. The control unit 48 controls the whole image forming apparatus 40.

The storage unit 47 stores a trading program 47a to ensure the trading. The trading program 47a for example, may be installed in the image forming apparatus 40 at production stage of the image forming apparatus 40, may be additionally installed in the image forming apparatus 40 from an external storage medium such as a Universal Serial Bus (USB) flash drive, or may be additionally installed in the image forming apparatus 40 via the network.

The control unit 48 includes, for example, a CPU, a ROM that stores a program and various data, and a RAM as a memory used as a work area of the CPU. The CPU executes the program stored in the storage unit 47 or the ROM.

The control unit 48 ensures an operation check function 48a, an unusable-state setting unit 48b, an uncancelable-state setting unit 48c, and a trading control unit 48d. The operation check function 48a executes the trading program 47a to check whether or not the trading object validly operates. The unusable-state setting unit 48b sets the trading object to a state where a specific function is unusable. The uncancelable-state setting unit 48c sets the trading object to an uncancelable state where the specific function is unusable. The trading control unit 48d controls the trading.

The operation check function 48a includes a process to check whether or not the trading object validly operates for each type of the trading object.

When setting the trading object to the state where the specific function is unusable, the unusable-state setting unit 48b stores information that the trading object is in the state where the specific function is unusable in the storage medium of the trading object. When setting the trading object to a state where the specific function is usable, the unusable-state setting unit 48b deletes the information that the trading object is in the state where the specific function is unusable from the storage medium of the trading object when the trading object is set to a state where.

When setting the trading object to the uncancelable state where the specific function is unusable, the uncancelable-state setting unit 48c stores information that the trading object is in the uncancelable state where the specific function is unusable in the storage medium of the trading object. When setting the trading object to a cancelable state where the specific function is unusable, the uncancelable-state setting unit 48c deletes the information that the trading object is in the uncancelable state where the specific function is unusable from the storage medium of the trading object.

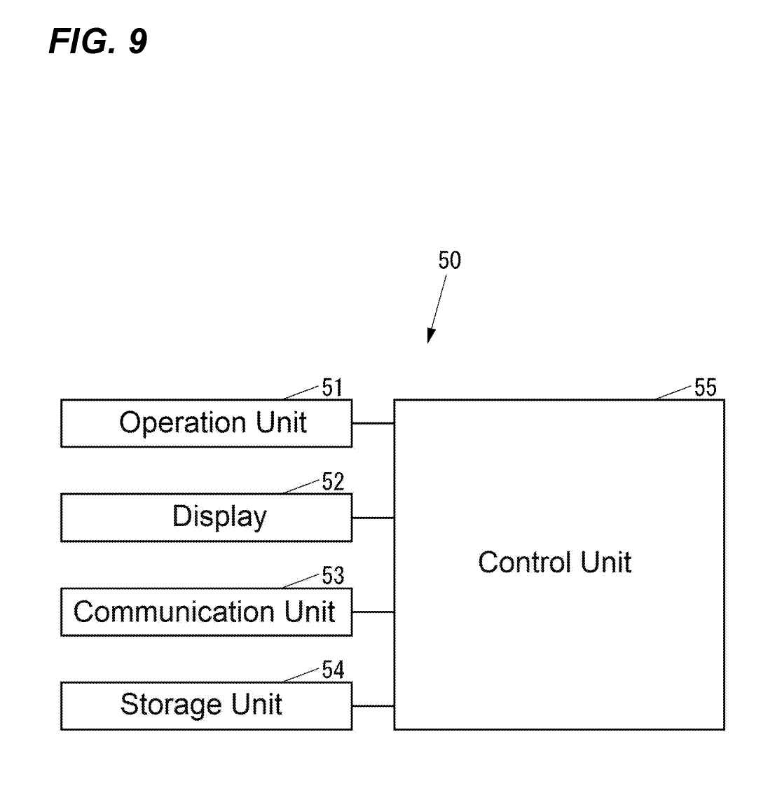

FIG. 9 illustrates a block diagram of the computer 50.

As illustrated in FIG. 9, the computer 50 includes an operation unit 51, a display 52, a communication unit 53, a storage unit 54, and a control unit 55. The operation unit 51 is an input device such as a keyboard and a computer mouse to which various operations are input. The display 52 is a display device such as an LCD that displays various kinds of information. The communication unit 53 is a communication device that communicates with an external device via the network such as the LAN or the Internet, or directly by wire or wirelessly without the network. The storage unit 54 is a non-volatile storage device such as a semiconductor memory and an HDD that store various kinds of information. The control unit 55 controls the whole computer 50.

The control unit 55 includes, for example, a CPU, a ROM that stores a program and various data, and a RAM used as a work area of the CPU. The CPU executes the program stored in the ROM or the storage unit 54.

Next, the operation of the trading system 10 will be described.

First, a description will be given of an operation of the image forming apparatus 40 when the trading object is set to the “sales mode.”

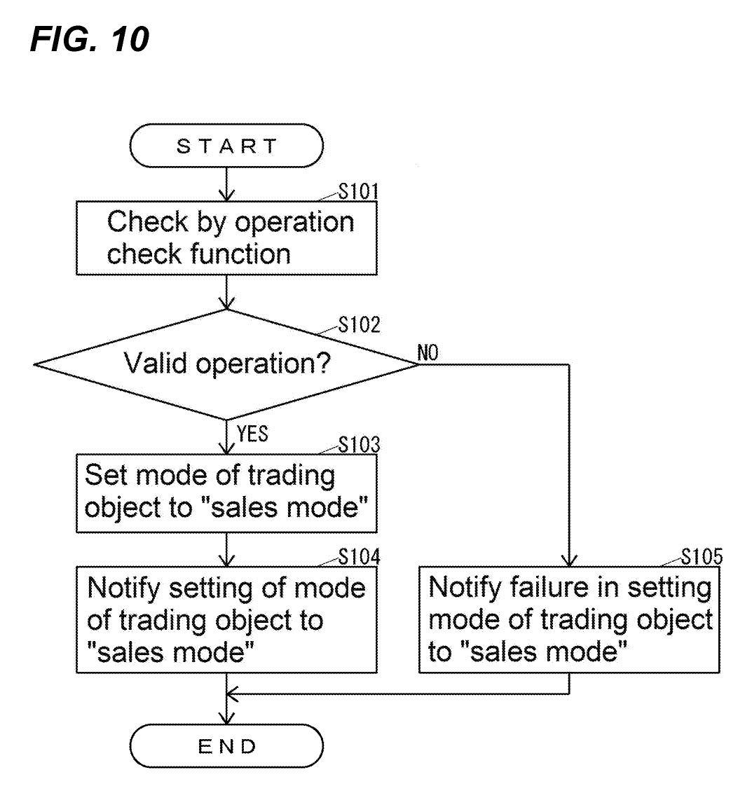

FIG. 10 illustrates the operation of the image forming apparatus 40 when the trading object is set to the “sales mode.”

The seller of the trading object can instruct the image forming apparatus 40 to set the trading object, which the seller wants to sell, to the “sales mode” via the operation unit 41. Here, when the trading object is the object used by the image forming apparatus 40, the image forming apparatus 40 is necessary to be communicable with the trading object. When the instruction to set the trading object to the “sales mode” is given, the unusable-state setting unit 48b of the image forming apparatus 40 executes the operation illustrated in FIG. 10.

As illustrated in FIG. 10, the unusable-state setting unit 48b causes the operation check function 48a to check whether or not the trading object validly operates (Step S101).

The unusable-state setting unit 48b determines whether or not the valid operation of the trading object has been confirmed in Step S101 (Step S102).

When the unusable-state setting unit 48b determines that the valid operation of the trading object has been confirmed in Step S101 in Step S102, the unusable-state setting unit 48b sets the trading object to the “sales mode” (Step S103), after that, gives notice of the setting of the trading object to the “sales mode” on the display 42 (Step S104), and terminates the operation illustrated in FIG. 10.

When the unusable-state setting unit 48b determines that the valid operation of the trading object has not been confirmed in Step S101, that is, determines that it has been confirmed that the trading object does not validly operate in Step S101 in Step S102, the unusable-state setting unit 48b gives notice of failure in setting the trading object to the “sales mode” on the display 42 (Step S105), and terminates the operation illustrated in FIG. 10.

Next, a description will be given of the operation of the trading system 10 when the seller of the trading object registers the trading object on the trading site 35a.

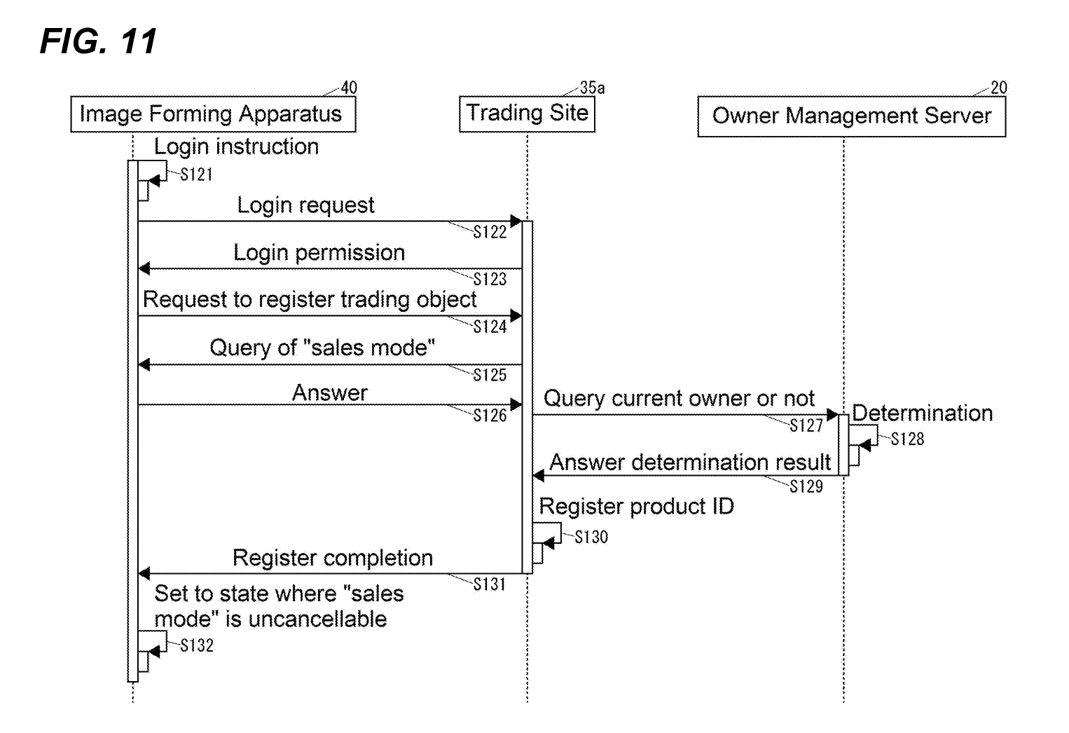

FIG. 11 illustrates the operation of the trading system 10 when the seller of the trading object registers the trading object on the trading site 35a.

The seller of the trading object can instruct the image forming apparatus 40 to register the trading object on the trading site 35a via the operation unit 41. Here, when the trading object is the object used by the image forming apparatus 40, the image forming apparatus 40 is necessary to be communicable with the trading object.

Upon receiving the instruction to register the trading object on the trading site 35a, as illustrated in FIG. 11, the trading control unit 48d of the image forming apparatus 40 instructs the seller of the trading object to login the trading site 35a by displaying on the display 42 (Step S121).

Next, when the user ID of the seller and authentication information such as a password are input via the operation unit 41, the trading control unit 48d requests the trading site 35a to permit the login with the combination of the input user ID and authentication information (Step S122).

When the trading site 35a permits the login requested in Step S122, the trading site 35a gives notice of the permission of the login to the image forming apparatus 40 (Step S123).

Upon receiving the notice of Step S123, the trading control unit 48d of the image forming apparatus 40 requests the trading site 35a to register the trading object (Step S124). Here, the request of Step S124 includes the product ID of the trading object.

Upon receiving the request of Step S124, when the trading object specified by the product ID notified in Step S124 has not been registered, the trading site 35a queries the image forming apparatus 40 whether or not the trading object requested to be registered in Step S124 is in the “sales mode” (Step S125).

Upon receiving the query of Step S125, the trading control unit 48d of the image forming apparatus 40 answers the trading site 35a whether or not the trading object requested to be registered in Step S124 is in the “sales mode” (Step S126).

Upon receiving the answer of Step S126, when the answer of Step S126 is that the trading object is in the “sales mode,” the trading site 35a queries the owner management server 20 whether or not the user specified by the user ID notified in Step S122, namely, the seller is the current owner of the trading object (Step S127).

Upon receiving the query of Step S127, the control unit 25 of the owner management server 20 determines whether or not the user specified by the user ID notified in Step S127 is the current owner of the trading object specified by the product ID notified in Step S127 based on the owner history information 24a (Step S128). Then, the control unit 25 answers the result of the determination of Step S128 to the trading site 35a (Step S129).

Upon receiving the answer that the seller of the trading object is the current owner of this trading object in Step S129, the trading site 35a registers the product ID notified in Step S124 (Step S130). That is, the trading object is put up for sale on the trading site 35a.

After the process of Step S130, the trading site 35a gives notice of the register completion of the trading object to the image forming apparatus 40 (Step S131).

Upon receiving the notice of Step S131, the uncancelable-state setting unit 48c of the image forming apparatus 40 sets the trading object to the state where the “sales mode” of the trading object is uncancelable (Step S132).

For changing the “sales mode” of the trading object from the uncancelable state to the cancelable state, it is necessary to use the cryptographic key matched with the trading object and stored in the cryptographic key information 24b.

Next, a description will be given of the operation of the trading system 10 when the seller of the trading object cancels the register of the trading object on the trading site 35a.

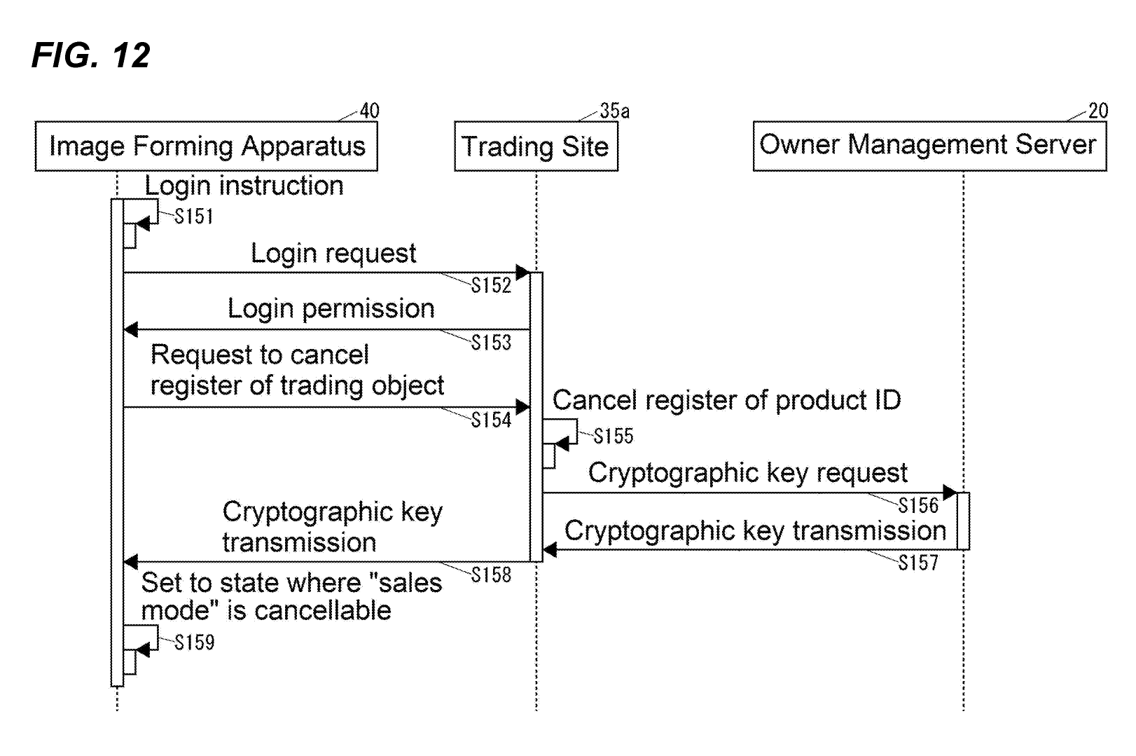

FIG. 12 illustrates the operation of the trading system 10 when the seller of the trading object cancels the register of the trading object on the trading site 35a.

The seller of the trading object can instruct the image forming apparatus 40 to cancel the register of the trading object on the trading site 35a via the operation unit 41 in certain cases, for example, when the trading object registered on the trading site 35a has not been purchased yet. Here, when the trading object is the object used by the image forming apparatus 40, the image forming apparatus 40 is necessary to be communicable with the trading object.

Upon receiving the instruction to cancel the register of the trading object on the trading site 35a, as illustrated in FIG. 12, the trading control unit 48d of the image forming apparatus 40 instructs the seller of the trading object to login the trading site 35a by displaying on the display 42 (Step S151).

Next, when the user ID of the seller and the authentication information such as the password are input via the operation unit 41, the trading control unit 48d requests the trading site 35a to permit the login with the combination of the input user ID and authentication information (Step S152).

When the trading site 35a permits the login requested in Step S152, the trading site 35a gives notice of the permission of the login to the image forming apparatus 40 (Step S153).

Upon receiving the notice of Step S153, the trading control unit 48d of the image forming apparatus 40 requests the trading site 35a to cancel the register of the trading object (Step S154). Here, the request of Step S154 includes the product ID of the trading object.

Upon receiving the request of Step S154, in the case where the trading object specified by the product ID notified in Step S154 has been registered, the trading site 35a cancels the register of the product ID of this trading object when the user specified by the user ID notified in Step S152 is determined to be the seller of this trading object based on the trading status of this trading object (Step S155). That is, the trading object is canceled to put up for sale on the trading site 35a.

Next, the trading site 35a requests the cryptographic key of the trading object specified by the product ID notified in Step S154 from the owner management server 20 (Step S156).

Upon receiving the request of Step S156, the control unit 25 of the owner management server 20 transmits the cryptographic key matched with the product ID notified in Step S156 in the cryptographic key information 24b to the trading site 35a (Step S157).

Upon receiving the cryptographic key transmitted in Step S157, the trading site 35a transmits the received cryptographic key to the image forming apparatus 40 (Step S158).

Upon receiving the cryptographic key transmitted in Step S158, the uncancelable-state setting unit 48c of the image forming apparatus 40 uses the received cryptographic key to set the trading object to the state where the “sales mode” of the trading object is cancelable (Step S159).

Next, a description will be given of the operation of the image forming apparatus 40 when the “sales mode” of the trading object is canceled.

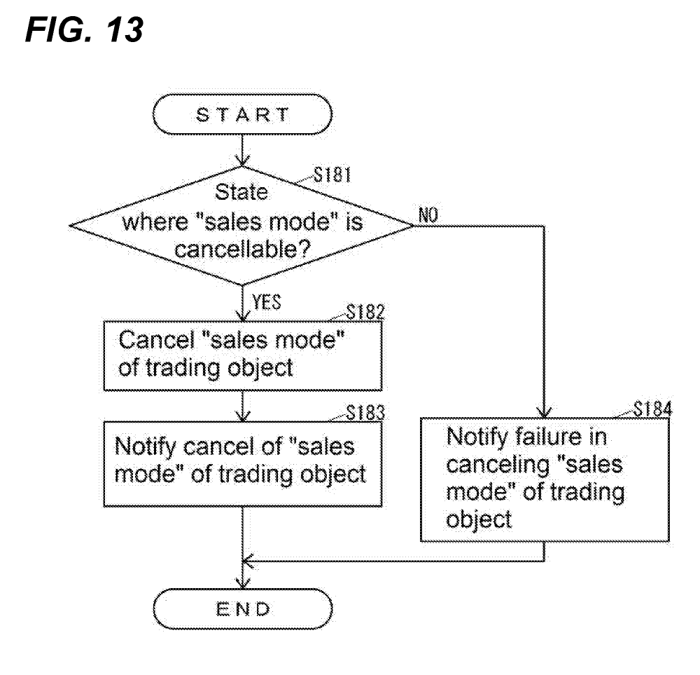

FIG. 13 illustrates the operation of the image forming apparatus 40 when the “sales mode” of the trading object is canceled.

The seller of the trading object can instruct the image forming apparatus 40 to cancel the “sales mode” of the trading object via the operation unit 41. Here, when the trading object is the object used by the image forming apparatus 40, the image forming apparatus 40 is necessary to be communicable with the trading object. Upon receiving the instruction to cancel the “sales mode” of the trading object, the unusable-state setting unit 48b of the image forming apparatus 40 executes the operation illustrated in FIG. 13.

As illustrated in FIG. 13, the unusable-state setting unit 48b determines whether or not the trading object is in the state where the “sales mode” is cancelable (Step S181).

When the unusable-state setting unit 48b determines that the trading object is in the state where the “sales mode” is cancelable in Step S181, the unusable-state setting unit 48b cancels the “sales mode” of the trading object (Step S182), after that, gives notice of the cancel of the “sales mode” of the trading object on the display 42 (Step S183), and terminates the operation illustrated in FIG. 13.

When the unusable-state setting unit 48b determines that the trading object is not in the state where the “sales mode” is cancelable in Step S181, the unusable-state setting unit 48b gives notices of failure in canceling the “sales mode” on the display 42 (Step S184), and terminates the operation illustrated in FIG. 13.

Next, a description will be given of the operation of the trading system 10 when the trading object registered on the trading site 35a is purchased.

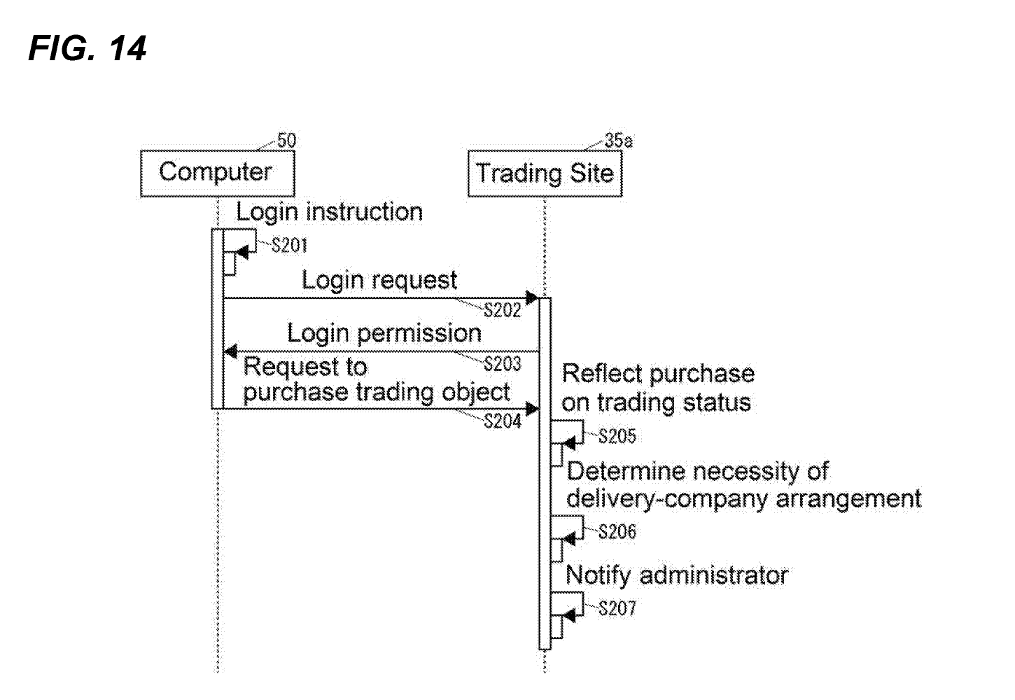

FIG. 14 illustrates the operation of the trading system 10 when the trading object registered on the trading site 35a is purchased.

The buyer of the trading object can instruct the computer 50 to purchase any one not yet purchased among the trading objects registered on the trading site 35a via the operation unit 51.

Upon receiving the instruction to purchase any one among the trading objects registered on the trading site 35a, as illustrated in FIG. 14, the control unit 55 of the computer 50 instructs the buyer of the trading object to login the trading site 35a by displaying on the display 52 (Step S201).

Next, when the user ID of the buyer and authentication information such as a password are input via the operation unit 51, the control unit 55 requests the trading site 35a to permit the login with the combination of the input user ID and authentication information (Step S202).

When the trading site 35a permits the login requested in Step S202, the trading site 35a gives notice of the permission of the login to the computer 50 (Step S203).

Upon receiving the notice of Step S203, the control unit 55 of the computer 50 requests the trading site 35a to purchase the trading object instructed to be purchased (Step S204). Here, the request of Step S204 includes the product ID of the trading object.

Upon receiving the request of Step S204, the trading site 35a reflects that the trading object requested to be purchased in Step S204 has been purchased by the buyer specified by the user ID notified in Step S202 on the trading status of this trading object (Step S205).

An address of the seller of the trading object is registered on the trading site 35a by the seller of the trading object before the purchase of the trading object by the buyer of the trading object. Similarly, an address of the buyer of the trading object is registered on the trading site 35a by the buyer of the trading object before the purchase of the trading object by the buyer of the trading object.

After the process of Step S205, the trading site 35a determines whether or not it is necessary to arrange the delivery company for the purchased trading object (Step S206). Here, when the type of the product, which is matched with the product ID notified in Step S204 in the product management information 34b, is included in the delivery-company arrangement information 34a, the trading site 35a determines that it is necessary to arrange the delivery company for the purchased trading object. Meanwhile, when the type of the product, which is matched with the product ID notified in Step S204 in the product management information 34b, is not included in the delivery-company arrangement information 34a, the trading site 35a determines that it is not necessary to arrange the delivery company for the purchased trading object.

On determining that it is necessary to arrange the delivery company for the purchased trading object in Step S206, the trading site 35a gives notice of the necessity of the arrangement of the delivery company for the purchased trading object to a destination of an administrator of the trading system 10 (Step S207). Then, the administrator of the trading system 10 can arrange the delivery company for shipping the trading object. That is, the administrator of the trading system 10 can cause the delivery company to go to the address of the seller of the trading object and collect the trading object, and after that, cause the delivery company to go to the address of the buyer of the trading object to deliver the trading object.

Even if the product is included in the delivery-company arrangement information 34a, it is not necessary for the trading site 35a to give notice of the necessity of the arrangement of the delivery company for the purchased trading object to the destination of the administrator of the trading system 10 depending on, for example, a request by at least one of the seller and the buyer of the trading object. Even if the product is not included in the delivery-company arrangement information 34a, the trading site 35a may give notice of the necessity of the arrangement of the delivery company for the purchased trading object to the destination of the administrator of the trading system 10 depending on, for example, a request by at least one of the seller and the buyer of the trading object.

When the notice of the necessity of the arrangement of the delivery company is not given to the destination of the administrator of the trading system 10, the seller of the trading object sends the trading object to the address of the buyer of the trading object.

The trading site 35a may use a known anonymous delivery system for delivering the trading object.

Next, a description will be given of the operation of the trading system 10 when the buyer of the trading object receives the trading object.

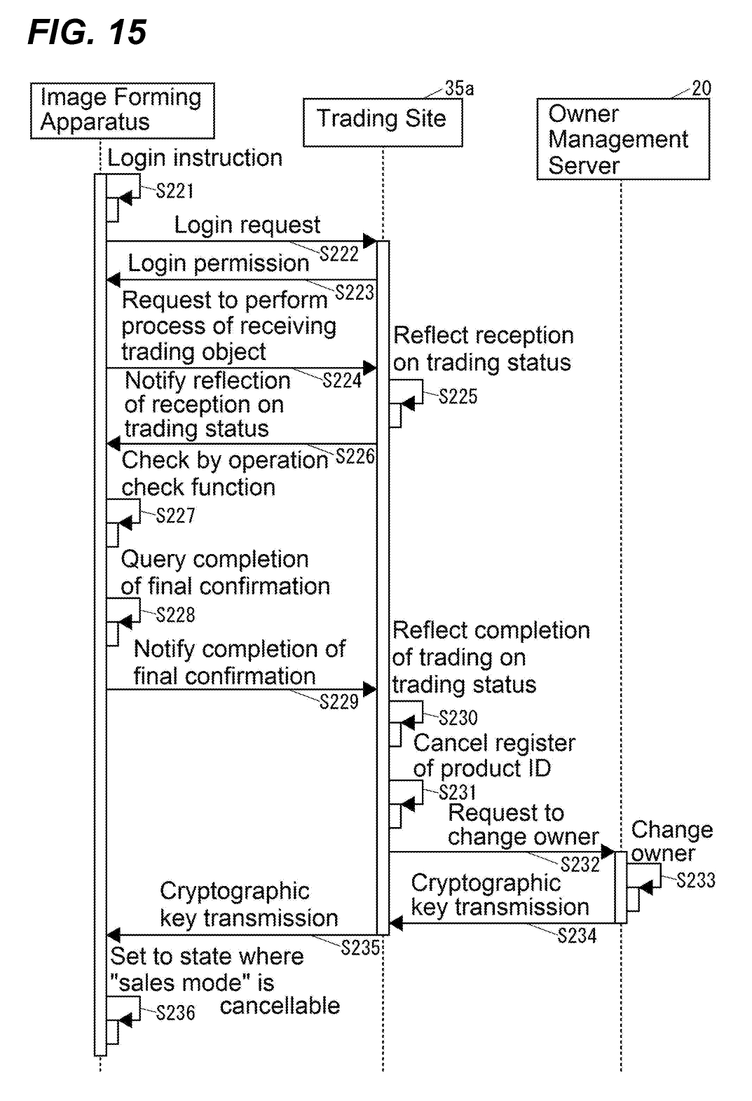

FIG. 15 illustrates the operation of the trading system 10 when the buyer of the trading object receives the trading object.

When the trading object is the image forming apparatus 40, the buyer of the trading object activates the image forming apparatus 40 upon receiving the trading object purchased on the trading site 35a. When the trading object is the object used by an image forming apparatus, the buyer of the trading object makes an image forming apparatus included in the trading system 10 communicable with the trading object and activates this image forming apparatus upon receiving the trading object purchased on the trading site 35a.

Hereinafter, in the descriptions of the operation of the trading system 10 when the buyer of the trading object receives the trading object, the image forming apparatus 40 when the trading object is the image forming apparatus 40 and the image forming apparatus made communicable with the trading object when the trading object is the object used by the image forming apparatus are simply referred to as the “image forming apparatus.”

As illustrated in FIG. 15, since the trading object is in the “sales mode,” the trading control unit of the image forming apparatus instructs the buyer of the trading object to login the trading site 35a by displaying on the display of the image forming apparatus (Step S221).

Next, when the user ID of the seller and the authentication information such as the password are input via the operation unit of the image forming apparatus, the trading control unit requests the trading site 35a to permit the login with the combination of the input user ID and authentication information (Step S222).

When the trading site 35a permits the login requested in Step S222, the trading site 35a gives notice of the permission of the login to the image forming apparatus (Step S223).

Upon receiving the notice of Step S223, the trading control unit of the image forming apparatus requests the trading site 35a to perform a process of receiving the trading object (Step S224). Here, the request of Step S224 includes the product ID of the trading object.

Upon receiving the request of Step S224, in the case where the trading object specified by the product ID notified in Step S224 has been registered, the trading site 35a reflects the reception of this trading object by the buyer on the trading status of this trading object when the user specified by the user ID notified in Step S222 is determined to be the buyer of this trading object based on the trading status of this trading object (Step S225). Then, the trading site 35a gives notice of the reflection of the reception of trading object on the trading status to the image forming apparatus (Step S226).

Upon receiving the notice of Step S226, the trading control unit of the image forming apparatus causes the operation check function of the image forming apparatus itself to check whether or not the trading object validly operates (Step S227).

When the valid operation of the trading object is confirmed in Step S227, the trading control unit queries completion of final confirmation of the trading object to the buyer by displaying on the display of the image forming apparatus (Step S228).

After the process of Step S228, upon receiving the answer of the completion of the final confirmation of the trading object via the operation unit of the image forming apparatus, the trading control unit gives notice of the completion of the final confirmation of the trading object to the trading site 35a (Step S229).

Upon receiving the notice of Step S229, the trading site 35a reflects the completion of the trading of the trading object on the trading status of this trading object (Step S230), and cancels the register of the product ID of this trading object (Step S231).

Next, the trading site 35a requests the owner management server 20 to change the owner of the trading object specified by the product ID notified in Step S224 to the user specified by the user ID notified in Step S222 (Step S232).

Upon receiving the request of Step S232, the control unit 25 of the owner management server 20 changes the owner history information 24a as requested in Step S232 (Step S233). Here, the control unit 25 inputs a date of receiving the request of Step S232 to the owner history information 24a as a date where a new owner became the owner of the trading object.

After the process of Step S233, the control unit 25 transmits the cryptographic key matched with the product ID of the trading object, whose owner is requested to be changed in Step S232, in the cryptographic key information 24b to the trading site 35a (Step S234).

Upon receiving the cryptographic key transmitted in Step S234, the trading site 35a transmits the received cryptographic key to the image forming apparatus (Step S235).

Upon receiving the cryptographic key transmitted in Step S234, the uncancelable-state setting unit of the image forming apparatus uses the received cryptographic key to set the trading object to the state where the “sales mode” of the trading object is cancelable (Step S236).

The buyer of the trading object can instruct the image forming apparatus to cancel the “sales mode” of the trading object via the operation unit of the image forming apparatus. Here, when the trading object is the object used by the image forming apparatus, the image forming apparatus is necessary to be communicable with the trading object. Upon receiving the instruction to cancel the “sales mode” of the trading object, the unusable-state setting unit of the image forming apparatus executes the operation similar to the operation illustrated in FIG. 13.

In the operations described above, when at least a part of the operations executed by the computer is executable by the image forming apparatus, the image forming apparatus may execute at least a part of the operations executed by the computer. Similarly, when at least a part of the operations executed by the image forming apparatus is executable by the computer, the computer may execute at least a part of the operations executed by the image forming apparatus.

Various timings are employable as a timing of payment for the trading object from the buyer to the seller. For example, the payment may be performed such that the buyer pays for the trading object to the administrator of the trading system 10 at the purchase of the trading object, and at the same time, the trading site 35a reflects the payment for the trading object from the buyer on the trading status of the trading object, subsequently the administrator of the trading system 10 pays for the trading object to the seller at the completion of the trading of the trading object, and at the same time, the trading site 35a reflects the payment for the trading object to the seller on the trading status of the trading object.

As described above, the trading system 10 includes the confirmation of the valid operation of the trading object by the operation check function of the image forming apparatus as a condition of the completion of the trading (Steps S125 and S126, and Steps S227 to S229). Accordingly, the valid operation of the trading object is confirmed by not a human but the operation check function of the image forming apparatus, thus ensuring reduction of a work to check whether or not the trading object validly operates.

The trading system 10 includes checking whether or not the trading object validly operates both before sending the trading object by the seller and after receiving the trading object by the buyer as the condition of the completion of the trading (Steps S125 and S126, and Steps S227 to S229). Accordingly, possibility of occurrence of a trouble due to the trading object not validly operating can be lowered.

The trading system 10 may omit any one of the process of Steps S125 and S126 and the process of Step S227.

In the trading system 10, the trading site 35a registers the trading object in the state where the specific function is unusable (Step S130), thus ensuring the lowered possibility of occurrence of a trouble due to the use of the trading object registered on the trading site 35a before the completion of the trading. As the trouble due to the use of the trading object registered on the trading site 35a before the completion of the trading, for example, a breakdown of the trading object and exhaustion of the trading object when the trading object is expendables are included.

The trading system 10 automatically sets the trading object whose valid operation has been confirmed by the operation check function to the state where the specific function is unusable (YES in Step S102, and Step S103), thus ensuring reduction of a work for setting the trading object to the state where the specific function is unusable.

The trading system 10 sets the trading object to the uncancelable state where the specific function is unusable when the trading object in the state where the specific function is unusable is registered on the trading site 35a (Step S132). This ensures the lowered possibility of the occurrence of the trouble due to the use of the trading object registered on the trading site 35a before the completion of the trading.

The trading system 10 sets the trading object to the cancelable state where the specific function is unusable when the seller has canceled the register of the trading object in the state where the specific function is unusable on the trading site 35a (Step S159). This enhances convenience.

The trading system 10 sets the trading object to the cancelable state where the specific function is unusable when the buyer of the trading object in the state where the specific function is unusable has become the owner of this trading object (Step S236). This enhances the convenience.

The trading system 10 manages the owner of the trading object with the owner history information 24a. Accordingly, when a trouble occurs on the trading object, a support by the manufacturer of the trading object can be appropriately provided to the owner of the trading object. For example, when a trouble is found on the product, the manufacturer can identify the current owner of the product on which the trouble is found based on the owner history information 24a, thus the appropriate support can be provided to the current owner of the product on which the trouble is found. A contract of product support between the manufacturer and the product owner may be automatically transferred from a previous owner to a new owner every time that the product owner changes.

The trading system 10 includes that the seller is the owner of the trading object at a time of the purchase of the trading object by the buyer from the seller as the condition of the completion of the trading (Step S129). This ensures a guarantee to the buyer that the trading object is an official product.

The cryptographic key used in Step S159 or S236 may be fixed, or may be generated by the control unit 48 of the image forming apparatus 40 every time that the process of Step S132 is performed. When the cryptographic key is generated by the control unit 48 of the image forming apparatus 40 every time that the process of Step S132 is performed, the control unit 48 of the image forming apparatus 40 gives notice of the combination of the generated cryptographic key and the product ID of the trading object corresponding to this cryptographic key to the owner management server 20 every time that the cryptographic key is generated. Then, upon receiving the notice of the combination of the cryptographic key and the product ID from the image forming apparatus 40, the control unit 25 of the owner management server 20 stores the combination of the cryptographic key and the product ID notified from the image forming apparatus 40 in the cryptographic key information 24b.

While the owner management system is configured by one computer in the embodiment, the owner management system may include a plurality of computers. Similarly, while the trading management system is configured by one computer in the embodiment, the trading management system may include a plurality of computers. The owner management system and the trading management system may share at least one computer that constitutes each of the owner management system and the trading management system.

While the electronic device of the disclosure is the image forming apparatus in the embodiment, the electronic device may be an electronic device other than the image forming apparatus, for example, a PC.

### Exemplary Embodiment of the Disclosure

The trading system of the disclosure includes a trading management system and an electronic device. The trading management system manages a trading. The electronic device has an operation check function. The operation check function checks whether an object of the trading validly operates for the trading. The trading management system includes at least one of a confirmation of the valid operation of the object by the operation check function before sending the object by a seller of the object and a confirmation of the valid operation of the object by the operation check function after receiving the object by a buyer of the object as a condition of a completion of the trading.

According to this configuration, the trading system of the disclosure includes the confirmation of the valid operation of the trading object by the operation check function of the electronic device as the condition of the completion of the trading. Accordingly, the valid operation of the trading object is confirmed by not a human but the operation check function of the electronic device, thus ensuring reduction of a work to check whether or not the trading object validly operates.

In the trading system of the disclosure, the trading management system may include both the confirmation of the valid operation of the object before sending the object by the seller and the confirmation of the valid operation of the object after receiving the object by the buyer as the condition of the completion of the trading.

According to this configuration, the trading system of the disclosure includes checking whether or not the trading object validly operates both before sending the trading object by the seller and after receiving the trading object by the buyer as the condition of the completion of the trading. Accordingly, possibility of occurrence of a trouble due to the trading object not validly operating can be lowered.

In the trading system of the disclosure, the electronic device may be configured to set the object to a state where a specific function is unusable, and the trading management system may register the object in the state where the specific function is unusable.

According to this configuration, in the trading system of the disclosure, the trading management system registers the trading object in the state where the specific function is unusable, thus ensuring the lowered possibility of occurrence of a trouble due to the use of the trading object registered on the trading management system before the completion of the trading.

In the trading system of the disclosure, the electronic device may automatically set the object to the state where the specific function is unusable when the operation check function has confirmed the valid operation of the object for registering the object to the trading management system.

According to this configuration, the trading system of the disclosure automatically sets the trading object whose valid operation has been confirmed by the operation check function in the state where the specific function is unusable, thus ensuring reduction of a work for setting the trading object to the state where the specific function is unusable.

In the trading system of the disclosure, the electronic device may set the object to an uncancelable state where the specific function is unusable when the object has been registered to the trading management system.

According to this configuration, the trading system of the disclosure sets the trading object to the uncancelable state where the specific function is unusable when the trading object in the state where the specific function is unusable is registered on the t trading management system. This ensures the lowered possibility of the occurrence of the trouble due to the use of the trading object registered on the trading management system before the completion of the trading.

The trading system of the disclosure may include an owner management system that manages an owner of the object. When the owner managed by the owner management system is the seller, the electronic device may set the object to the cancelable state where the specific function is unusable when the seller has canceled the register of the object to the trading management system.

According to this configuration, the trading system of the disclosure sets the trading object to the cancelable state where the specific function is unusable when the seller has canceled the register of the trading object in the state where the specific function is unusable on the trading management system. This enhances convenience.

The trading system of the disclosure may include an owner management system that manages an owner of the object. The owner management system may change the owner from the seller to the buyer when the trading management system has managed the completion of the trading. The electronic device may set the object to the cancelable state where the specific function is unusable when the owner managed by the owner management system is the buyer.

According to this configuration, the trading system of the disclosure sets the trading object to the cancelable state where the specific function is unusable when the buyer of the trading object in the state where the specific function is unusable has become the owner of this trading object. This enhances the convenience.

The trading system of the disclosure may include an owner management system that manages an owner of the object. The owner management system may change the owner from the seller to the buyer when the trading management system has managed the completion of the trading.

According to this configuration, the trading system of the disclosure manages the owner of the trading object. Accordingly, when a trouble occurs on the trading object, a support can be appropriately provided to the owner of the trading object.

In the trading system of the disclosure, the trading management system may have the condition of the completion of the trading, and the condition includes that the seller is the owner of the object and managed by the owner management system at a time of a purchase of the object by the buyer from the seller.

According to this configuration, the trading system of the disclosure includes that the seller is the owner of the trading object at a time of the purchase of the trading object by the buyer from the seller as the condition of the completion of the trading. This ensures a guarantee to the buyer that the trading object is an official product.

The electronic device of the disclosure includes an operation check function that checks whether an object of a trading validly operates for the trading. The electronic device automatically sets the object to a state where a specific function is unusable when the operation check function has confirmed the valid operation of the object.

According to this configuration, the electronic device of the disclosure checks whether or not the object of the trading validly operates by the operation check function, and automatically sets the trading object whose valid operation has been confirmed by the operation check function to the state where the specific function is unusable. This ensures reduction of a work to check whether or not the trading object validly operates and a work for setting the trading object in the state where the specific function is unusable.

### Effect of the Disclosure

The trading system and the electronic device of the disclosure can reduce the work to check whether or not the trading object validly operates.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A trading system comprising:
a trading management system that manages a trading;
an electronic device that has an operation check function, the operation check function checking whether an object of the trading validly operates for the trading,
wherein the trading management system includes at least one of a confirmation of the valid operation of the object by the operation check function before sending the object by a seller of the object and a confirmation of the valid operation of the object by the operation check function after receiving the object by a buyer of the object, as a condition of a completion of the trading.

2. The trading system according to claim 1,
wherein the trading management system includes both the confirmation of the valid operation of the object before sending the object by the seller and the confirmation of the valid operation of the object after receiving the object by the buyer, as the condition of the completion of the trading.

3. The trading system according to claim 1,
wherein the electronic device is configured to set the object to a state where a specific function is unusable, and
the trading management system registers the object in the state where the specific function is unusable.

4. The trading system according to claim 3,
wherein the electronic device automatically sets the object to the state where the specific function is unusable when the operation check function has confirmed the valid operation of the object for registering the object to the trading management system.

5. The trading system according to claim 3,
wherein the electronic device sets the object to an uncancelable state where the specific function is unusable when the object has been registered to the trading management system.

6. The trading system according to claim 5, comprising,
an owner management system that manages an owner of the object,
wherein when the owner managed by the owner management system is the seller, the electronic device sets the object to the cancelable state where the specific function is unusable when the seller has canceled the register of the object to the trading management system.

7. The trading system according to claim 5, further comprising,
an owner management system that manages an owner of the object,
wherein the owner management system changes the owner from the seller to the buyer when the trading management system has managed the completion of the trading, and
the electronic device sets the object to the cancelable state where the specific function is unusable when the owner managed by the owner management system is the buyer.

8. The trading system according to claim 1, further comprising,
an owner management system that manages an owner of the object,
wherein the owner management system changes the owner from the seller to the buyer when the trading management system has managed the completion of the trading.

9. The trading system according to claim 8,
wherein the trading management system has the condition of the completion of the trading, and the condition includes that the seller is the owner of the object and managed by the owner management system at a time of a purchase of the object by the buyer from the seller.

10. An electronic device comprising,
an operation check function that checks whether an object of a trading validly operates for the trading,
wherein the electronic device automatically sets the object to a state where a specific function is unusable when the operation check function has confirmed the valid operation of the object.
